(19) United States
(12) Patent Application Publication
(10) Pub. No.: US 2005/0035499 A1
(43) Pub. Date: Feb. 17, 2005

(54) Method for producing foamed structural parts that are mixed with vegetable carrier materials

(76) Inventor: Friedhelm Beckmann, Hiddenhausen (DE)

Correspondence Address: JORDAN AND HAMBURG LLP, 122 EAST 42ND STREET, SUITE 4000, NEW YORK, NY, 10168, US

(21) Appl. No.: 10/275,621

(22) PCT Filed: May 25, 2001
(86) PCT No.: PCT/DE01/01999

(30) Foreign Application Priority Data
May 30, 2000 (DE) 100 26 757.2

(51) Int. Cl. B29C 44/02

(52) U.S. Cl. 264/415; 264/417; 264/418; 264/422; 264/51; 264/53; 264/85

(57) ABSTRACT

The invention relates to a method for producing foamed structural parts, comprising the following steps: admixing to a plastified base material to be foamed a particulate, vegetable carrier material that contains a physical propellant, adjusting the temperature and the pressure of the base material such that the physical propellant does not evaporate, and reducing the pressure of the base material and/or increasing the temperature of the base material so that the physical propellant at least partially evaporates, thereby expanding the base material. The inventive method is further characterized in that the carrier material consists at least partially of shavings.

### METHOD FOR PRODUCING FOAMED STRUCTURAL PARTS

The invention relates to a method for producing foamed structural parts, for which a particulate, vegetable carrier material, containing a physical blowing agent, is mixed into a plasticized basic material, which is to be foamed, the temperature and pressure of the basic material being adjusted so that the physical blowing agent does not evaporate, and subsequently the pressure of the basic material being lowered and/or the temperature of the basic material being increased, so that the physical blowing agent is evaporated at least partially and the basic material is foamed.

It is a requirement of the production of foamed structural parts, especially in the automobile sector, that the weight be as low as possible without, however, significantly affecting the basic mechanical properties. For this reason, chemical or physical blowing agents and combinations thereof are added in different proportions by weight to plastics for producing foamed structural parts.

Chemical blowing agents have the advantage that, by mixing different blowing agent substances, they lead to a large variation in reaction temperatures, so that the processing on appropriately designed production machines is relatively easy. It is, however, a disadvantage of such blowing agents that, after the reaction, residual substances remain in the basic material and in the carrier material and thus affect their properties and lead to a deterioration in the surface in the form of streaks.

As a rule, physical blowing agents lead to finer foam structures. However, the homogeneous introduction of a physical blowing agent into a plastic melt is significantly more difficult than the introduction of a chemical blowing agent. Because of the finer foam structure, the mechanical properties of a structural part, which is to be produced, are affected less than in the case in which chemical blowing agents are used.

It is well known that, aside from noble gases, a liquid, such as water, may be used as physical blowing agent, which is supplied, as in U.S. Pat. No. 3,940,467, in an extruder, the material subsequently being transferred to a mold cavity and foamed.

The preparation of a foamed, thermoplastic rubber is known from U.S. Pat. No. 5,607,983, water being supplied to the plasticized material, water and the melt being homogenized and the plasticized composition subsequently being molded into a foamed profile. Moreover, vegetable fibers and vegetable fiber powders are supplied to the extruded composition, however, independently of the mixing with water or of the water-containing gel material.

However, since it has turned out that the homogeneous mixing of water with a plasticized basic material, which is to be foamed, is exceedingly difficult, attempts have been made to introduce water into a melt with the help of water-absorbing carrier materials, for example, as disclosed in U.S. Pat. No. 4,649,164. However, the additives described there lead to residues in the polymer, which have a negative effect on the basic properties.

It is an object of the invention to indicate a method, with which a material, previously regarded as a waste product in the recovery of vegetable fibers, can advantageously be used.

Pursuant to the invention, this objective can be accomplished by a method for producing foamed structural parts, for which a particulate, vegetable carrier material, containing a physical blowing agent, is mixed into a plasticized, basic material, which is to be foamed, the temperature and pressure of the basic material being adjusted, so that the physical blowing agent is not evaporated, and, subsequently, the pressure of the basic material is lowered and/or the temperature of the basic material increased, so that the physical blowing agent is evaporated at least partially and the basic material is foamed, the method being distinguished by the fact that the carrier material consists at least partially of shives.

Experiments have shown that the mechanical properties of the foamed materials not only do not deteriorate but, on the contrary, can even be improved through the use of vegetable carrier materials.

Preferably, the physical blowing agent, which may be an inert gas, such as carbon dioxide or nitrogen, is added in a liquid, solid or gaseous state. The physical blowing agent may also be water, alcohol or a mixture thereof. However, other liquid media, which lead to the formation of a foam, are also conceivable. The addition of moisture can be controlled by adjusting the water content of the carrier material.

Shives are woody components, which are obtained during the production of vegetable fibers, surround the vegetable fibers and can adsorb up to 500% of their own volume of water.

The degree of fineness of the shives can be adjusted between powdery and a maximum length of 15 to 20 mm, depending on the property profile desired, by a prior processing step, as a result of which further reinforcing effects can be achieved. Combinations of different shive lengths are also possible. The fine grain components of the shives furthermore function as nucleating agents in the plastic melt and initiate a reaction for the foam formation.

Provisions can been made so that the carrier material consists partly or completely of bast fibers and/or of shives of bast fiber plants and/or of shives with incompletely detached bast fibers. In so doing, provisions can, furthermore, be made so that the shives have a length of between 2 and 50 mm and so that the bast fibers connected to the shives have a length between 2 and 100 mm.

Provisions can be made so that the carrier material is at least partially powdery.

Provisions can furthermore been made that the basic material is or is not cross-linked. The basic material may be a synthetic or a biological material.

The use of biological basic materials with the inventive carrier materials leads to structural parts, which can be broken down biologically, so that a particularly advantageous recycling behavior is achieved.

In a development of the method, provisions can been made so that the basic material immediately before it is brought in to the mold cavity or into the orifice region of an extruder, is brought to a temperature, at which the liquid commences to evaporate.

In a further development, provisions can been made so that the liquid-containing carrier material is mixed with a first, plasticized basic material, the temperature and pressure of the first basic material being adjusted so that the liquid does not evaporate and, immediately before the introduction into a mold cavity or into the orifice region of an extruder, a second basic material, which is compatible with the first basic material and the temperature of which is so high, that a mixture temperature results, which leads to at least a partial evaporation of the liquid, being mixed with the first basic material.

The two plasticized basic materials or melts are brought together immediately before the orifice of a mold cavity or shortly before the nozzle opening of the processing machine and mixed or homogenized with one another by appropriate equipment. In this connection, it is advantageous to keep the mixing time or the heating time as short as possible, in order to avoid that the liquid, acting as foaming agent, escapes from the homogenized melt excessively fast, so as to impair the foaming effect.

Provisions may be made so that the first basic material is ethylene vinyl acetate (EVA) with a melting temperature of between 85° and 120° C. or a metallocene-PP with a melting temperature between 130° C. and 160° C. The second basic material may be polypropylene, which has or has not been reinforced and has a melting point between 190° and 120° C.

The process is conducted preferably to that the liquid is evaporated completely essentially when the mixture of the first and second basic material has been sprayed into the mold cavity or has been extruded from the orifice of an extruder

In a further development of the invention, provisions may be made so that the evaporation of the liquid is initiated and/or supported by supplying energy, especially microwave or high frequency energy. The particularly advantageous effects with regard to a fine, homogeneous foam structure can be achieved in that, shortly before the outlet regions from the machine nozzle, the material is heated rapidly or essentially suddenly. The energy may be supplied over the length of the heating segment.

Further developments of the invention arise out of the remaining independent claims.

1. A method for producing foamed structural parts, comprising admixing a particulate, vegetable carrier material with a physical blowing agent, mixing the resultant admixture into a plasticized basic material which is to be foamed, the carrier material being comprised of shives, setting the temperature and pressure of the basic material so that the physical blowing agent does not evaporate or expand, and subsequently lowering the pressure of the basic material and/or increasing the temperature of the basic material so that the physical blowing agent is evaporated at least partially or expanded sufficiently to foam the basic material.

2. The method of claim 1, wherein the physical blowing agent which is admixed with carrier material is in a liquid, solid or gaseous state.

3. The method of claim 1 or 2, wherein the physical blowing agent is an inert gas.

4. The method of claim 1 or 2, wherein the physical blowing agent is water, alcohol, or a mixture thereof.

5. The method of claim 1 or 2, wherein the carrier material comprises vegetable fibers.

6. The method of claim 1 or 2, wherein the carrier material comprises bast fibers and/or of shives of bast fiber plants and/or of shives with some bast fibers still attached thereto.

7. The method of claim 6, wherein the shives are between 2 mm and 50 mm in length and the bast fibers attached to the shives are between 2 mm and 100 mm in length.

8. The method of claim 1 or 2, wherein the carrier material comprises powder.

9. The method of claim 5, wherein the vegetable fibers or shives are up to 20 mm in length.

10. The method of claim 1 or 2, wherein the basic material is selected from the group consisting of cross-linked and non-cross-linked materials.

11. The method of claim 1 or 2, wherein the basic material is a synthetic or a biological material.

12. The method of claim 1 or 2, wherein the physical blowing agent is a liquid and the method further comprising feeding the admixture thereof with the carrier material mixed with the basic material into a mold cavity or into an orifice region of an extruder and immediately therebefore heating the basic material to a temperature at which the liquid commences to evaporate.

13. The method of claim 1 or 2, wherein the physical blowing agent is a liquid and the method further comprises mixing said first plasticized basic material, heretofore maintained at a temperature so that the liquid blowing agent does not evaporate, with a second plasticized basic material which is compatible with said first basic material and is at a temperature sufficiently high that the temperature of the mixture of the first and second basic materials results in sufficient evaporation of the liquid blowing agent to cause foaming of the mixture of the first and second basic materials.

14. The method of claim 13, wherein the first basic material comprises ethylene vinyl acetate having a melting temperature of 85° to 90° C.

15. The method of claim 13, wherein the second basic material comprises reinforced or unreinforced polypropylene having a melting temperature of 190° to 220° C.

16. The method of claim 1 or 2, wherein the liquid is evaporated completely and essentially only when said feeding of the basic material into a mold cavity or said extrusion from the nozzle of an extruder occurs.

17. The method of claim 1 or 2, wherein the temperature of the basic material is raised by applying microwave or high frequency energy thereto.

18. The method of claim 1 or 2, wherein the blowing agent is liquid and the pressure of the basic material is lowered and/or the temperature of the basic material is increased within a time sufficiently short to substantially maximize the foaming.

19. The method of claim 1 or 2, wherein the carrier comprises shives, the blowing agent is an inert gas and the admixing comprises supplying the carrier and the inert gas to an autoclave and subsequently mixing together the carrier and the inert gas.

20. The method of claim 1 or 2, wherein the carrier comprises shives and the method further comprises feeding a flowing melt of the basic material through an injection molding machine or an extruder and feeding the admixture of the blowing agent and the carrier into the flowing melt in the injection molding machine or the extruder.

21. The method of claim 3, wherein the inert gas is carbon dioxide or nitrogen.

22. The method of claim 12, wherein the extruder comprises an extrusion nozzle and the feeding of the mixture of the basic material with the admixture of the carrier material and the blowing agent into an orifice region of an extruder comprises extruding the mixture through said nozzle.
